(19) United States
(12) Patent Application Publication
(10) Pub. No.: US 2013/0217267 A1
(43) Pub. Date: Aug. 22, 2013

(54) CONNECTOR ASSEMBLY CAPABLE OF SUSTAINING LARGE CURRENT

(71) Applicant: Rongzhe GUO, Shenzhen City (CN)

(72) Inventor: Rongzhe GUO, Shenzhen City (CN)

(21) Appl. No.: 13/401,774

(22) Filed: Feb. 21, 2012

(51) Int. Cl. H01R 24/00

(52) U.S. Cl. CPC H01R 24/00
USPC 439/660

(57) ABSTRACT

The connector assembly capable of sustaining a large amount of current contains a male member and a female member. The male member contains a male insulating casing, male power terminal assemblies, and male signal terminal assemblies; and the female member contains a female insulating casing, female power terminal assemblies, and a female signal terminal assembly. Each male power terminal assembly has five male contract branches where neighboring male contact branches are alternately separated, each male contract branch has a knee section, the middle three male contact branches are wider than the other two branches whose width is one half of that of the larger middle branches so that the lateral normal force would be uniform. The advantages of this structure are that, under the same current rating, the cost for material and electroplating is less, and the form factor can be further reduced.

### TECHNICAL FIELD OF THE INVENTION

The present invention is generally related to connectors, and more particular to a connector assembly capable of sustaining a large amount of current.

### DESCRIPTION OF THE PRIOR ART

Existing connectors can be generally categorized into three categories: mechanical connectors, electrical connectors, and environmental connectors. Among them, the electrical connectors such as signal connectors, power connectors, hybrid connectors, etc., are most widely utilized. For ordinary applications, only a small amount of current would pass through the electrical connectors. For some special applications such as those for aviation, space, communication, and traffic, connectors capable of sustaining a large amount of current are required. The power terminals of existing power or hybrid connectors are mechanically manufactured using brass or bronze having conductivity 10%˜30% IACS. These terminals of existing power or hybrid connectors are of limited current sustaining capability, of sizable dimensions, and of high costs.

### SUMMARY OF THE INVENTION

Therefore, the present invention provides a connector assembly capable of sustaining a large amount of current with enhance temperature control, reduced cost, and wider applicability.

The connector assembly of the present invention contains a male member and a female member. The male member contains a male insulating casing, male power terminal assemblies, and male signal terminal assemblies; and the female member contains a female insulating casing, female power terminal assemblies, and a female signal terminal assembly. Each male power terminal assembly has five male contract branches where neighboring male contact branches are alternately separated, each male contract branch has a knee section, the middle three male contact branches are wider than the other two branches whose width is one half of that of the larger middle branches so that the lateral normal force would be uniform.

Preferably, each male power terminal assembly has a large metallic piece as its main body with the male contact branches extended from an edge. The female power terminal assembly contains two independent, separated, and opposing small metallic pieces. The male contact branches are inserted and sandwiched between the two small metallic pieces. The neighboring male contact branches are contacted with different small metallic pieces.

Preferably, there are six male power terminal assemblies and two signal terminal assemblies within the male insulating casing. The front part of the inside of the male insulating casing has an accommodation space. The back part of the inside of the male insulating casing has a base piece with six male power terminal slots in parallel, one for each male power terminal assembly. With these numerous male power terminal assemblies, the connector assembly is capable of sustaining a large amount of current. By separating the male power terminal assemblies apart in separate slots, the heat produced can be easily dissipated.

Preferably, each male power terminal slot has a width three to six times to that of the large metallic piece. Each male power terminal slot has notches within which the large metallic piece of a male power terminal assembly is embedded with the male contact branches extended in the accommodation space. During assembly and disassembly, the large metallic piece can be conveniently pushed and pulled out of the notches. With the pressure exerted by the notches, the large metallic piece is effectively positioned.

Preferably, a blocking element is configured in each male power terminal slot. Correspondingly, a protruding element is configured on each large metallic piece. When the female member is plugged into the male member, the power terminal assemblies are under a tendency of being pushed backward. By the blocking elements' stopping the protruding elements, the large metallic pieces are not pushed out of the male insulating casing.

Compared to the prior art, the advantages of the present invention are as follows.

The male contact branches are sandwiched between the small metallic pieces of the female power terminal assembly. Each male power terminal assembly has five male contract branches where the middle three male contact branches are wider than the other two branches whose width is one half of that of the larger middle branches. As such, under the same current rating, the present invention's cost for material and electroplating is less, and the form factor can be further reduced.

The connector assembly of the present invention uses metallic pieces as the main bodies for the power terminal leads so that their large area is capable of sustaining a large amount of current. In addition, the metallic pieces provide greater heat dissipating surfaces for quick and effective heat dissipation under a large amount of current. As such, the temperature of the connector assembly is controlled within a safe range.

The large metallic pieces are placed inside wider male power terminal slots, leaving enough room for heat dissipation, thereby controlling the temperature of the connector assembly.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a connector assembly according to an embodiment of the present invention.

FIG. 2 is a perspective diagram showing the connector assembly of FIG. 1 when its male and female members are separated.

FIG. 3 is a front diagram showing a male insulating casing of the connector assembly of FIG. 1.

FIG. 4 is a front diagram showing the male member of the connector assembly of FIG. 2.

FIG. 5 is a perspective diagram showing the arrangement of male terminal assemblies of the connector assembly of FIG. 1.

FIG. 6 is a side diagram showing a male power terminal assembly of the connector assembly of FIG. 1.

FIG. 7 is a top diagram showing a male power terminal assembly of the connector assembly of FIG. 1.

FIG. 8 is a perspective diagram showing a female insulating casing of the connector assembly of FIG. 1.

FIG. 9 shows the female insulating casing of FIG. 8 from another angle.

FIG. 10 is a perspective diagram showing the arrangement of female terminal assemblies of the connector assembly of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

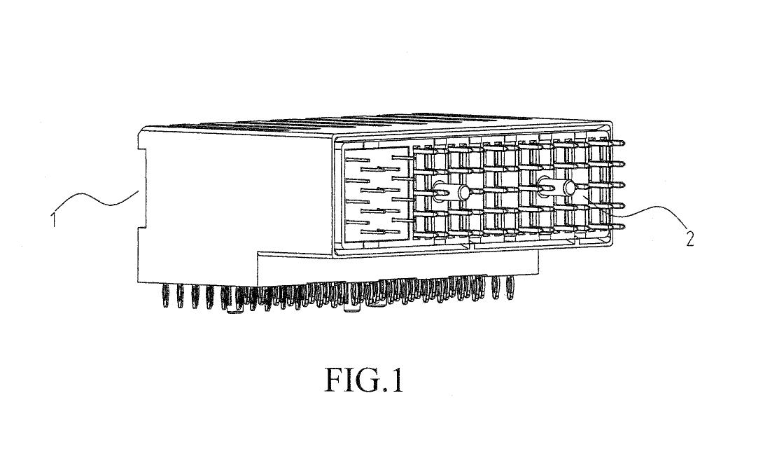

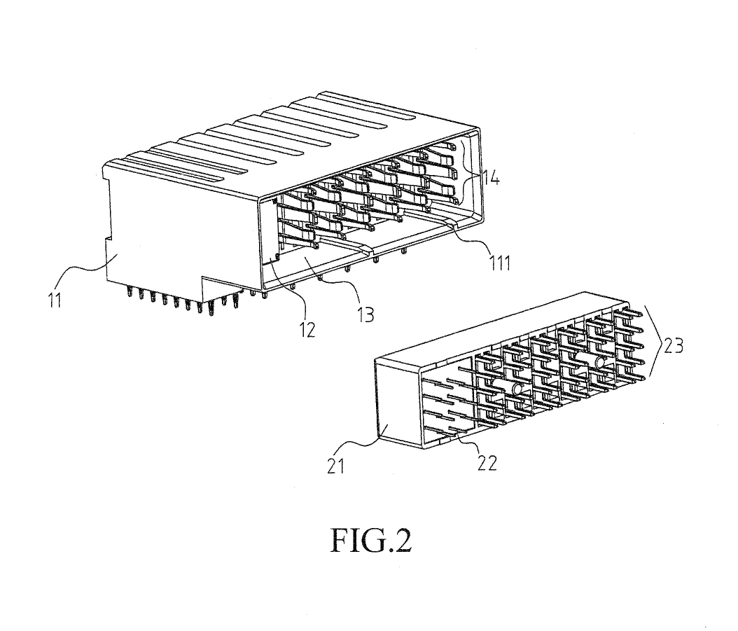

As shown in FIGS. 1 and 2, a connector assembly capable of sustaining large current according to the present invention contains a male member 1 and a female member 2 where the two are jointed together in use.

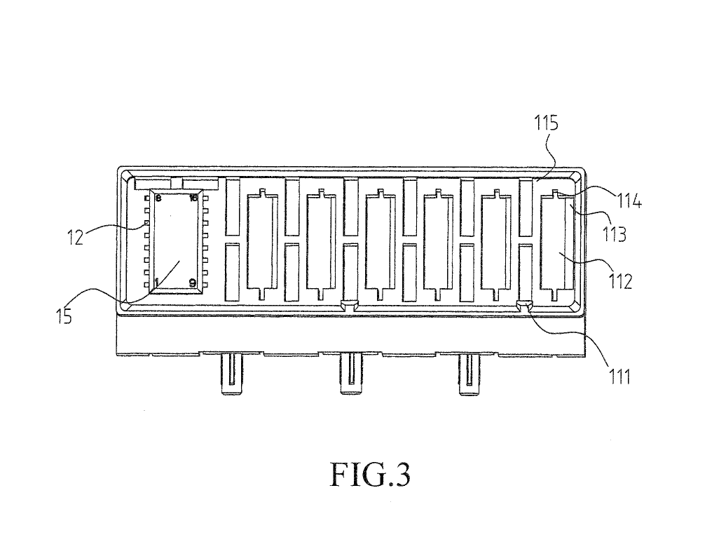

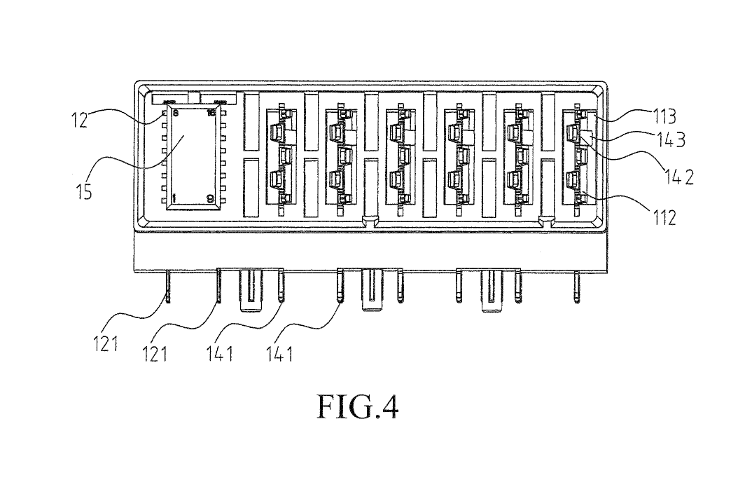

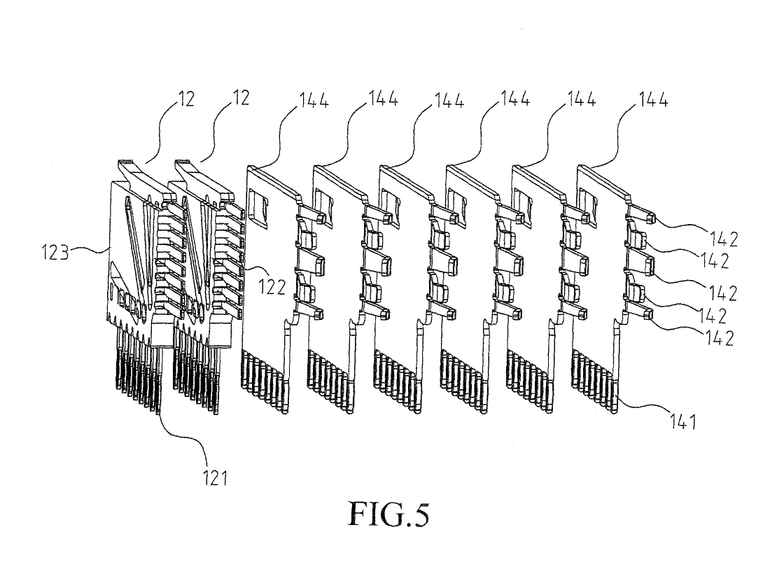

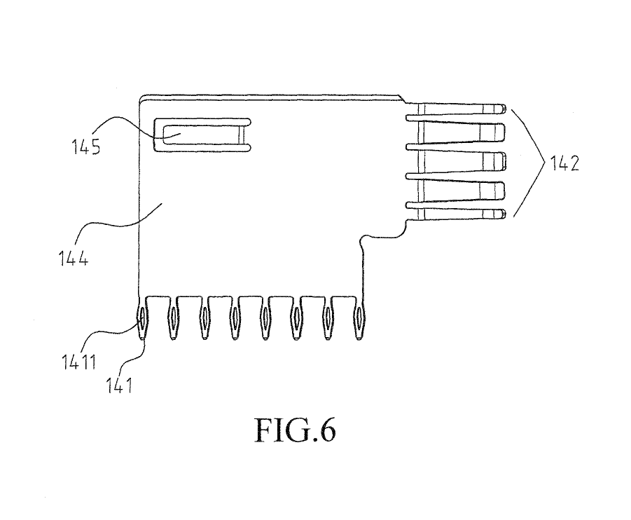

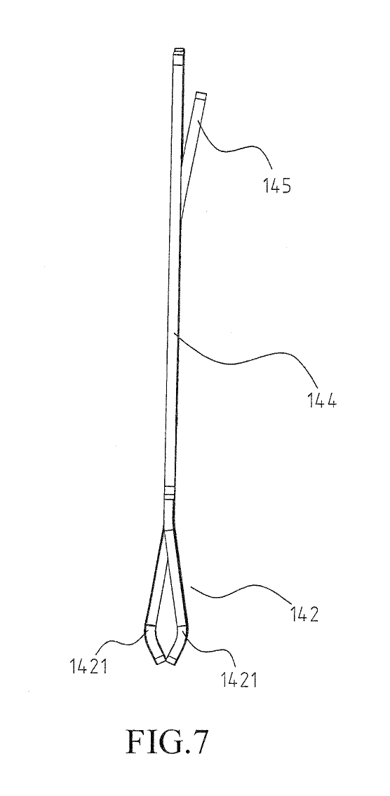

The male member 1 contains a male insulating casing 11, mail power terminal assemblies 14, and male signal terminal assemblies 12. As shown in FIGS. 5 and 6, each mail power terminal assembly 14 has a large metallic piece 144 as its main body. The large metallic piece 144 has 5 male contact branches 142 extended from a first edge, and 8 male supporting leads 141 extended from a second edge perpendicular to the first edge. For the 5 male contact branches 142, three in the middle are larger than the outmost two whose width is one half of the larger middle ones. As such, when the male and female members 1 and 2 are coupled, the lateral normal force would be uniform. Additionally, the advantages of this structure are that, under the same current rating, the cost for material and electroplating is less, and the form factor can be further reduced. Each male contract branch 142 is placed with a layer of copper preventing redox reaction to the metallic surface. As shown in FIG. 7, the outer half of each male contact branch 142 has a knee section 1421 and the knee sections 1421 of neighboring male contact branches 142 are bended towards opposite directions. As shown in FIGS. 3 and 4, there are six male power terminal assemblies 14 and two signal terminal assemblies 12 within the male insulating casing 11. The front part of the inside of the male insulating casing 11 has an accommodation space 13 whose shape matches the shape of the female member 2. A number of guiding elements 111 are configured along a bottom side of the accommodation space 13. Correspondingly, a number of guiding grooves 25 are configured on the female insulating casing of the female member 2. The back part of the inside of the male insulating casing 11 has a base piece 115 with six male power terminal slots 112 in parallel. Each male power terminal slot 112 has a width three to six times to that of the large metallic piece 144. When a large metallic piece 144 is placed inside a male power terminal slot 112, there is enough room for heat dissipation, thereby controlling the temperature of the connector assembly. Each male power terminal slot 112 has notches 114 within which a large metallic piece 144 of a male power terminal assembly 14 is embedded. The male contact branches 142 are then extended in the accommodation space 13. The large metallic pieces 144 therefore can be conveniently installed and replaced. A blocking element 113 is configured in each male power terminal slot 112. On the other hand, a protruding element 145 is configured on each large metallic piece 144. When a female member 2 is plugged into a male member 1, the power terminal assemblies 14 are under a tendency of being pushed backward. However, by the blocking elements 113's stopping the protruding elements 145, the large metallic pieces 144 are not pushed out of the male insulating casing 11. The base piece 115 also has two male signal terminal slots (not numbered) in parallel with the male power terminal slots 112. Each male signal terminal assembly 12 is configured on a frame 123 which in turn is configured in a male signal terminal slot. Male signal supporting leads 121 and male signal contact leads 122 are extended from two edges of the male signal terminal assembly 12 and the leads 121 and 122 are perpendicular to each other. The male signal contact leads 122 are configured in a bulged opening 15.

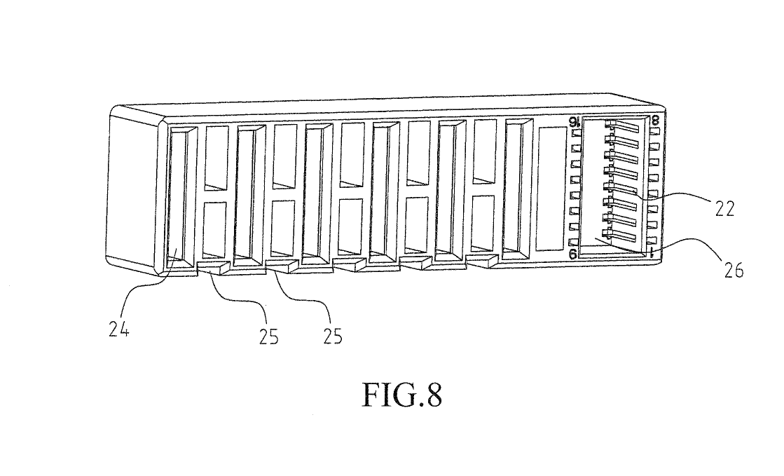

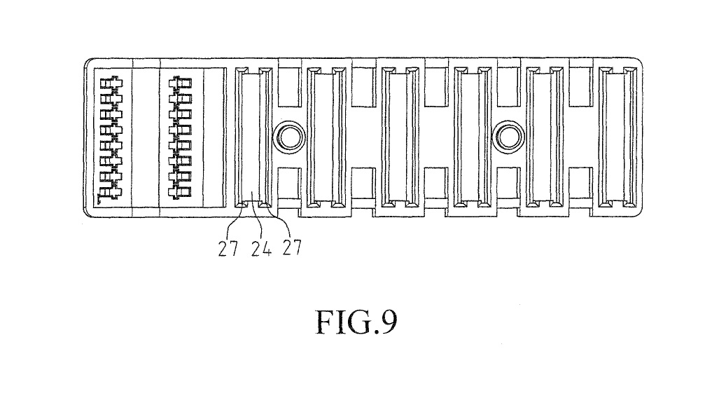

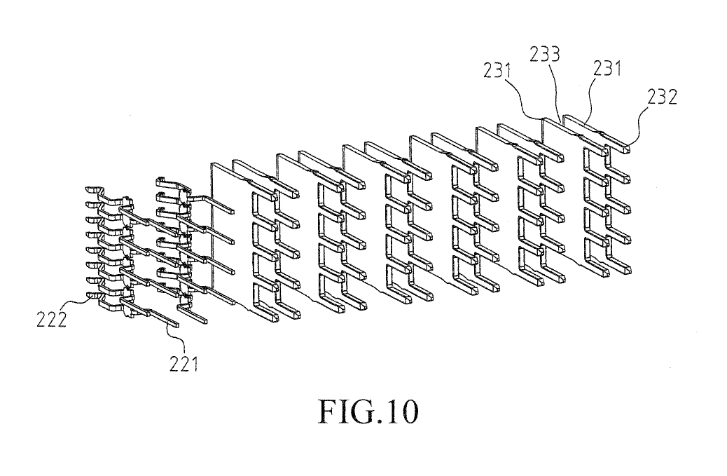

As shown in FIG. 10, the female member 2 contains a female insulating casing 21, female power terminal assemblies 23, and a female signal terminal assembly 22. Each female power terminal assembly 23 contains two independent, separated, and opposing small metallic pieces 231 and a number of power leads 232 are extended from an edge of each small metallic piece 231. Copper is plated on the surface of each small metallic piece 231. As shown in FIGS. 8 and 9, six parallel female power terminal slots 24 are configured inside the female insulating casing 21, each corresponding to a female power terminal assembly 23. Within each female power terminal slot 24, there are two notches 27 for the embedment of the two small metallic pieces 231 and, as such, a gap 233 is reserved in between for the insertion of the male contact branches 142. The female signal terminal assembly 22 is configured inside the female insulting casing 21 which contains two sets of eight signal leads 221. One end of each signal lead 221 is configured inside an indented opening 26. The signal leads 221's other ends are alternately opposing.

When the male and female members 1 and 2 are coupled, the guiding grooves 25 on the female insulating casing 21 are aligned with the guiding elements 111 in the accommodation space 13 of the male insulating casing 11, and the female member 2 are forced into the accommodation space 13. After the female member 2 is completely inserted, the coupling is accomplished. After coupling, the male contact branches 142 of each male power terminal assembly 14 are inserted into the corresponding gap 233 between two small metallic pieces 231 of a female power terminal assembly 23. And the knee sections 1421 of neighbouring male contact branches 142 are contacted with different small metallic pieces 231. The bulged opening 15 of the male member 1 and the indented opening 26 of the female member 2 are joined to each other. In the meantime, the male signal terminal assemblies 12 of the male member 1 are connected with the female signal terminal assembly 22 of the female member 2.

The connector assembly of the present invention uses metallic pieces as the main bodies for the power terminal leads so that their large area is capable of sustaining a large amount of current. In addition, the metallic pieces provide greater heat dissipating surfaces for quick and effective heat dissipation under a large amount of current. As such, the temperature of the connector assembly is controlled within a safe range.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A connector assembly, comprising:
a male member comprising a male insulating casing, male power terminal assemblies, and male signal terminal assemblies; and
a female member comprising a female insulating casing, female power terminal assemblies, and a female signal terminal assembly;
wherein each male power terminal assembly has five male contract branches; neighboring male contact branches are alternately separated; each male contract branch has a knee section; the middle three male contact branches is wider than the other two branches whose width is one half of that of the larger middle branches.

2. The connector assembly according to claim 1, wherein each male power terminal assembly has a large metallic piece as main body; the mail contract branches are extended from an edge of the large metallic piece; the female power terminal assembly contains two independent, separated, and opposing small metallic pieces; the male contract branches are inserted and sandwiched between the small metallic pieces of the female power terminal assembly; and neighboring male contact branches are contacted with different small metallic pieces.

3. The connector assembly according to claim 2, wherein six male power terminal assemblies and two signal terminal assemblies are within the male insulating casing; the front part of the inside of the male insulating casing has an accommodation space; the back part of the inside of the male insulating casing has a base piece with six male power terminal slots in parallel; and each male power terminal slot corresponds to a male power terminal assembly.

4. The connector assembly according to claim 3, wherein each male power terminal slot has a width three to six times to that of the large metallic piece; each male power terminal slot has notches within which a large metallic piece of a male power terminal assembly 14 is embedded; and the male contact branches are extended in the accommodation space.

5. The connector assembly according to claim 3, wherein a blocking element is configured in each male power terminal slot; a protruding element is configured on each large metallic piece; and the protruding element is stopped by the blocking element.
